(19) United States
(12) Patent Application Publication
(10) Pub. No.: US 2004/0116107 A1
(43) Pub. Date: Jun. 17, 2004

(54) Method for configuring mobile phones to have consumer selected functions

(76) Inventors: Trevor Pei, Shenzhen (CN); Jack Hsu, Tu-Chen (TW); Chain Lin, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/641,804

(22) Filed: Aug. 15, 2003

(30) Foreign Application Priority Data
Dec. 13, 2002 (TW) 91136038

(51) Int. Cl. H04M 11/00

(52) U.S. Cl. 455/418; 455/403

(57) ABSTRACT

A method for configuring a mobile phone to have consumer selected functions includes the steps of: designing application software having different functions; collecting the designed application software into a database; selecting predetermined application software having desired functions from the database; and inputting the selected application software into corresponding storage devices of a mobile phone; Thus the mobile phone has the functions that the consumer wants. Application software can be reconfigured and upgraded when the consumer has some new or higher demands for functions. The high cost of purchasing a new mobile phone is thus avoided by the consumer when the consumer wants to upgrade functions.

### BACKGROUND OF THE INVENTION

1. Field of the Invention

The present invention relates to a method for configuring a mobile phone to have consumer selected functions.

2. Related Art

Currently, mobile phones are becoming more and more useful in people's lives, since they provide convenient and prompt contact between different persons. Mobile phones having more attractive appearances and new, practical functions continue to come on the market, which promotes more and more consumers to buy mobile phones having preferred characteristics. To meet consumer demand for mobile phones having more variety, many attractive enclosures are now provided to change the appearance of a mobile phone. Different dulcet rings and music are also available on the Internet for download to mobile phones, which provides consumers with more choices to select their favorite rings and music.

Trends indicate that consumers have a desire to own mobile phones having their selected functions and styles. However, conventional mobile phones now on the market only provide the consumers with a fixed set of functions, which they may like or not like. In other words, consumers are provided with mobile phones having unchangeable application softwares chosen by manufacturers, instead of application softwares chosen by consumers themselves. As a result, many consumers probably buy mobile phones which have some functions they do not like. In addition, many mobile phones which have new and more useful functions are coming on the market. Many consumers thus find themselves disposing of their old mobile phones and buying new mobile phones which have functions they desire. No doubt, this increases costs significantly for the consumers.

Therefore, a mobile phone changeably configurable to have a consumers' chosen functions is desired.

### SUMMARY OF THE INVENTION

An object of the present invention is to provide a method for configuring a mobile phone to have consumer selected functions.

To achieve the above object, a method for configuring a mobile phone to have consumer selected functions includes the steps of: designing application softwares having different functions; collecting the designed application softwares into a database; selecting predetermined application softwares having desired functions from the database; and inputting the selected application softwares into corresponding storage units of a mobile phone. Thus the mobile phone has functions that a consumer desires. Application software can be reconfigured and upgraded when the consumer has new or higher demands for functions. The high cost of purchasing a new mobile phone is thus avoided by the consumer when the consumer wants to upgrade functions.

These and additional objects, features and advantages of the present invention will become more apparent after reading the following detailed description of a preferred embodiment of the invention.

### DETAILED DESCRIPTION OF THE INVENTION

A mobile phone generally comprises a CPU (Central Processing Unit), a storage unit electrically coupled to the CPU, application softwares stored in the storage unit, a switch module, and other necessary modules, such as an antenna module, speaker module, and so on. The CPU is used to carry out system programs and some functional programs, and to process signals from other units coupled to the CPU. The storage unit is divided into different areas, such as a ROM (Read-Only Memory) area, an EPROM (Erasable Programmable Read-Only Memory) area, and a RAM (Random Access Memory) area. The application softwares are stored in the different areas of the storage unit to implement some predetermined functions. For example, a program for implementing download is predetermined and stored in the ROM area. The switch module is coupled to the CPU and the storage unit. Desired functions can be obtained by downloading and installing corresponding application softwares in the mobile phone.

A method for configuring a mobile phone to have consumer selected functions includes the following steps: first, a variety of application softwares which implement different functions are designed according to consumers' demands and potential demands. These demands includes color of background lighting, calling pattern, methods of inputting characters, the types of rings, procedures for connecting with other pertinent electronic devices, and so on.

Second, these designed application softwares are collected together and classified into different categories according to their characteristics, and are put into a database in an external computer or other external equipment.

Third, a consumer can select his or her favorite characteristics for a mobile phone, including appearance, color, and other modules when buying the mobile phone. Fourth, the consumer selects functions he or she desires in the mobile phone. A technician or a salesman having a technology background then chooses corresponding application softwares from the database for implementing the functions which the consumer desires. A data transfer line is used to electrically connect an interface of the mobile phone to an interface of the external computer. Download of application softwares selected program stored in the database is then actuated, and the selected softwares are downloaded from the external computer and stored in the EPROM area of the consumer's new phone. The desired application softwares are thus installed in the mobile phone. Thus, a completely personalized mobile phone having selected functions is configured.

Of course, the application softwares in the EPROM area of the consumer's phone can be reconfigured and upgraded using this method, when the consumer has new demands for functions. The consumer can obtain his or her favorite functions for the mobile phone cheaply, since he or she doesn't need to replace the entire mobile phone. The consumer thus avoids the high cost of purchasing a new mobile phone.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A method for configuring a mobile phone to have consumer selected functions, comprising the steps of:
(1) designing application softwares having different functions;
(2) collecting said application softwares into a database;
(3) selecting predetermined application softwares having desired functions from the database; and
(4) inputting the selected application software into corresponding storage units of the mobile phone;
whereby a mobile phone having a consumers' desired functions is obtained.

2. The method of claim 1, wherein in step (2) the application software are classified into different categories according to their characteristics before being putting into the database.

3. The method of claim 1, wherein in step (4) the storage unit of the mobile phone comprises an EPROM area, and the selected application softwares are stored in the EPROM area.

4. A method for configuring a mobile phone to have consumer selected functions, comprising the steps of:
(1) providing a database containing application softwares having different functions therein;
(2) selecting corresponding application softwares to implement a consumers' desired functions from the database; and
(3) installing the application softwares in the mobile phone.

5. The method of claim 4, wherein the application softwares are installed in a storage device of the mobile phone.

6. A method of providing customized and personalized mobile phones, comprising steps of:
(1) providing different hardwares in an inventory;
(2) providing different softwares in a database;
(3) selecting some of said different hardwares to assemble a body of mobile phone;
(4) selecting some of said different softwares and installing said selected softwares into the assembled mobile phone;
(5) activating said assembled and installed mobile phone.

7. The method of claim 6, wherein said mobile phone is allowed to uninstall the original softwares and reinstall new ones for either upgrading or other applications.
